(19) United States
(12) Patent Application Publication
(10) Pub. No.: US 2006/0146655 A1
(43) Pub. Date: Jul. 6, 2006

(54) Server for routing connection to client device

(75) Inventor: Erwin Rinaldo Meinders, Eindhoven (NL)

Correspondence Address: HAYNES AND BOONE, LLP, 901 MAIN STREET, SUITE 3100, DALLAS, TX, 75202, US

(73) Assignee: Koninklijke Philips Electronics N.V.

(21) Appl. No.: 10/562,899

(22) PCT Filed: Jun. 30, 2004
(86) PCT No.: PCT/IB04/51059

§ 371 Date: Dec. 29, 2005

(30) Foreign Application Priority Data
Jul. 2, 2003 (EP) 03101973.0

(51) Int. Cl. G11B 11/00

(52) U.S. Cl. 369/16

(57) ABSTRACT

The present invention relates to a device and a corresponding method for making a master record carrier (60) for use in making a stamper (64) for making replicated read-only optical record carriers (90). Rather than using irradiation with photons or electrons, it is proposed to make use of thermal-mechanical deformation of a thin organic layer in the record carrier. Therefore, the device according to the invention comprises: a recording head (1) for recording information in an information layer (62) of a master record carrier (60), said recording head (1) including a heatable tip (2) which can be displaced in at least one direction, a displacement means (3, 5, 6, 9) for displacing said tip (2) in the at least one direction, a heating means (7) for heating said tip (2) and a control unit (8) for controlling said heating means and said displacement means such that for recording a mark said tip is heated and displaced to be in contact with said information layer causing an indentation therein.

The present invention relates to a device and a corresponding method for making a master record carrier for use in making a stamper for making replicated read-only optical record carriers. Further, the present invention relates to a device and a corresponding method for making a stamper. Still further, the present invention relates to record carriers for use as master record carriers in those devices and methods.

An important trend in optical recording is the strive for higher data capacities. An evolutionary increase in data capacity has been seen from single layer CD (650 Mb) to DVD (4.7 GB) and BD (25 GB). In addition, a capacity doubling was obtained by introducing dual-layer recording and more recording layers in a single recording medium. Other methods to increase data capacity are also foreseen, like magneto-optical recording and near field recording. Two-dimensional data storage in one plane, currently studied, is also a way to increase capacity. The anticipated data capacity of two-dimensional data storage is estimated to be at least a factor 1.5. An increased data density would especially be beneficial for a small form factor optical disc (SFFO).

The idea of 2D data storage is based on encoding data in a two-dimensional pattern. The data track pitch and bit length are much smaller than the optical spot. In this way, marks present in the adjacent tracks are also partly readout by the sides of the optical spot; this is the well-known optical cross talk. In two-dimensional optical recording, this optical cross-talk is utilized to store data in the second (radial) direction as well. In a suitable system, it was proposed to use a multi-spot readout assembly to retrieve the information.

The two-dimensional data pattern can be made with E-beam recording or with conventional laser beam recording (LBR). The LBR system can be operated with a single laser spot, the laser pulse pattern being synchronized with the data in the adjacent tracks to allow recording a two-dimensional data pattern. Another possibility is to use multiple laser spots such that a two-dimensional data pattern can be recorded with intrinsic synchronization of data by the fixed position of the laser spots. LBR is used to illuminate a photosensitive polymer layer. The exposed areas are chemically removed via etching, such that physical pits remain in the resist layer. A stamper is made from this surface topography, the stamper being subsequently used to replicate media. Such a process of making a two-dimensional medium is very similar to that used for standard optical disc ROM manufacturing (such as for CD, DVD and BD). The multiple beam set-up is a complex system and synchronization in the single beam option is difficult to achieve. Another drawback of the LBR system is the limited spot size since the smallest spot size for far field deep UV mastering is about 150 nm while it is 120 nm for liquid immersion mastering.

It is therefore an object of the present invention to provide a device and method for making a master record carrier as well as a device and method for making a stamper avoiding the above described disadvantages and which are in particular suitable for making a master record carrier or stamper, respectively, for two-dimensional optical storage.

This object is achieved according to the present invention by a device for making a master record carrier as claimed in claim 1 comprising:

a recording head for recording information in an information layer of a master record carrier, said recording head including a heatable tip which can be displaced in at least one direction,

a displacement means for displacing said tip in the at least one direction,

a heating means for heating said tip and
a control unit for controlling said heating means and said displacement means such that for recording a mark said tip is heated and displaced to be in contact with said information layer causing an indentation therein.

This object is further achieved by a device for making a stamper as claimed in claim 12, comprising:

a device for making a master record carrier as claimed in claim 1,

means for depositing a metallic layer on top of said information layer, and

means for separating said deposited metallic layer from said information layer to obtain said metallic layer forming said stamper.

Corresponding methods are claimed in claims 10 and 14. Suitable record carriers according to the present invention for use as master record carriers are defined in claims 15 and 16. Preferred embodiments of the invention are defined in the dependent claims.

According to the invention a different method to make a data pattern, in particular a two-dimensional pattern, of small pits that is read-out by a focused laser spot is proposed. Rather than using irradiation with photons of a photo-sensitive layer (LBR) or with electrons of an electron-sensitive layer (E-beam mastering) the invention makes use of thermal-mechanical deformation of a thin information layer, preferably made of an organic material. The recording apparatus of the invention consists of one or more tiny AFM-like (AFM=Atomic Force Microscopy) tips that can be (independently) heated and used to indent a thin layer, preferably of organic material. When the hot tip interacts with the thin layer, a small indentation is locally formed in the layer, resulting from the combined action of mechanical pressure and thermal softening of the (organic) material (such as melting, decomposition or evaporation).

Such tips are known in general from Atomic Force Microscopy (AFM), where the tips are not heated, or from Scanning Thermal Microscopy (SThM) where the tips are also heated and where they can, for example, be used to measure the thermal conductivity of thin sputter-deposited films (E. Meinders “Measurement of the thermal conductivity of thin layers using a scanning thermal microscope”, J. Mater. Res., Vol. 16, No. 9, 2001, pp. 2530-2543).

According to a preferred embodiment the heating means comprises a current source for providing an electrical current for flowing through said tip when a mark shall be recorded. This is an effective and simple method to heat the tip which, of course, must be made of an electrically conducting material that heats up when an electrical current flows therein. Preferred materials are platinum or tungsten in the form of thin wires which are, according to a further embodiment, covered by a tube, in particular a Wollaston tube. In addition, the tip can be included in a Wheatstone bridge as one bridge element, said Wheatstone bridge forming the control unit. The flow of heat to the environment then cools down the tip resulting in a reduction of its electrical resistance. A change in resistance causes an unbalance of the bridge which is then compensated for via a feedback loop.

In a preferred embodiment the displacement means for displacing the tip in the at least one direction, i.e. in the direction perpendicular to the surface of the record carrier, comprises a light generation unit for providing a light beam, in particular a laser beam, to be directed onto deflection means included in the recording head, and a light detection unit for detection of light deflected by said deflection means. The displacement of the reflected laser beam on the light detection unit is then used as a measure for the surface topology of the record carrier and can be used to control the displacement of the tip. For actual displacement of the recording head it is preferred to use an actuator, in particular a piezo-electric actuator or a thermal-mechanical cantilever, which is preferably included in said recording head. Such an actuator can be controlled by an electrical current so that preferably the same current at is used for heating the tip can be used for control of the actuator. In the simplest way the same current flowing through the tip and the actuator heats up the tip and causes the actuator to bring the tip into contact with the surface of the record carrier. If no current flows through the tip and the actuator, the tip is brought back into its original position, i.e. not in contact with the surface of the record carrier, and is cooled down. However, two separate electrical currents can also be used for separate control.

The shape of the tip can be made dependent on the desired shape of the indentations in the information layer. Preferably, the tip has a conical shape of which the top faces the information layer but even the size and angles of the conus of such a tip can be modified according to the desired shape of the indentations and the thickness of the information layer.

In order to enable a simultaneous recording of a number of bits not only a single recording head but an array of recording heads each comprising a heatable tip which can be independently heated and displaced upon control of the control unit, is provided. This embodiment either enables the recording of several bits of a one-dimensional code or of a number of bits, e.g. a complete code-word, of a two-dimensional code at the same time, enabling much faster recording compared to a device having only a single recording head. Moreover, the present invention allows for much higher density due to the possible small size of the tips wherein the array of tips is easily controllable. This small size is in particular of importance for making a two-dimensional data pattern with data sizes much smaller than the size of the optical spot.

The described device results in a master record carrier which can be advantageously used in a device for making a stamper. Therefore, it is proposed to deposit a metallic layer on top of the information layer of the master record carrier into which the bits of the desired code have been recorded, and further to separate the deposited metallic layer from the information layer to obtain the metallic layer itself forming said stamper. The steps for making such a stamper are generally known in the art, for instance from WO 02/13194 or JP-A-102 55 319 to which reference is herewith made, so that no further details shall be given here.

Further advantages can be obtained if the master record carrier further comprises an additional photo-sensitive layer between the information layer and the substrate layer. Using such a record carrier a mask can be made by the indentations generated with the hot tip in the thin (organic) information layer. This information embedded in the mask (i.e. in the information layer) can then be transferred into the photo-sensitive layer by UV illumination, i.e. a focus laser beam is not required. This has the advantage that small pits can be used, potentially smaller than they are achievable with conventional mastering technologies which are based on a focus laser beam. After the illumination with the UV source, conventional development procedures are used to create the pits in the illuminated photo-sensitive layer. In this way, the hot tip is only used to make the mask, while the photo-sensitive layer is finally the actual layer carrying the information. An additional advantage thereof is the reduced proximity effect, i.e. writing an indentation will possibly cause rims at the edge of the indentation so that a crater is formed. By reducing the thickness of the indented layer (i.e. the information layer functioning as mask) this “crater effect” is minimized by this embodiment.

Preferred embodiments of record carriers for use as master record carriers in the devices and methods of the present invention are defined in claims 16 to 19. The record carrier according to claim 16 comprises, between the substrate layer and the information layer, an additional interface layer, made of metal or an insulating material, by which the heat diffusion through the information layer is controlled, in this way controlling the size of the written pits.

According to another embodiment a record carrier comprises an additional photo-sensitive layer between the substrate layer and the information layer by which the above described effects can be obtained and which enables the use of a much thinner (organic) information layer. Additionally, also in this embodiment an interface layer, metallic or insulating, can be provided between the photo-sensitive layer and the information layer.

Generally, the record carriers used according to the present invention comprise an information layer substantially made of an organic material. However, it is generally possible to use the invention in combination with an information layer substantially made of an inorganic material.

The invention will now be described in more detail with reference to the drawings in which

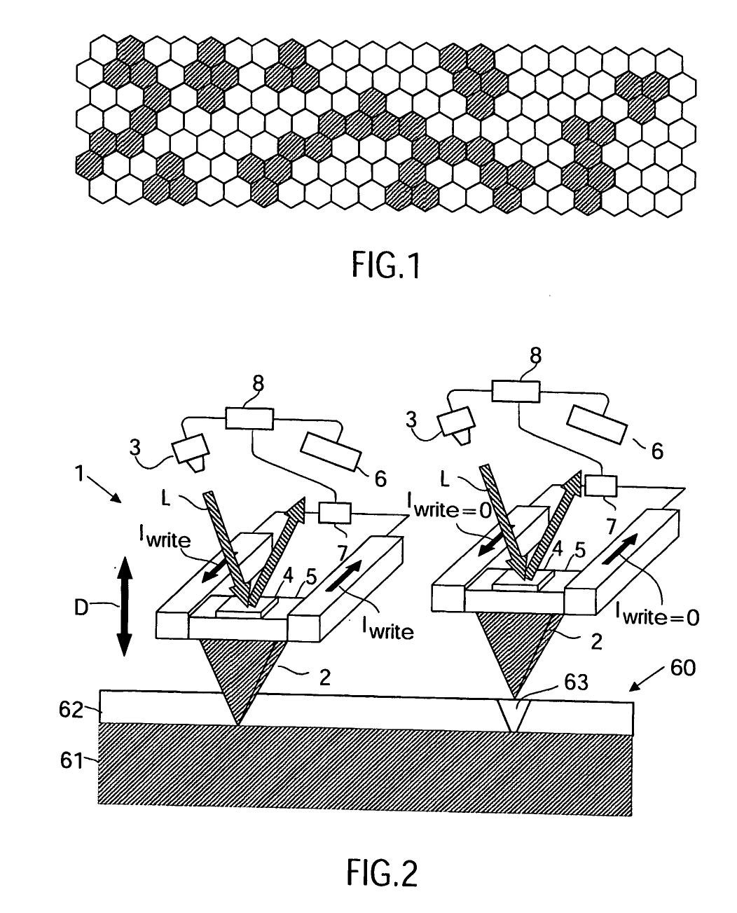

FIG. 1 shows an example of a two-dimensional data pattern,

FIG. 2 shows a first embodiment of a device according to the invention,

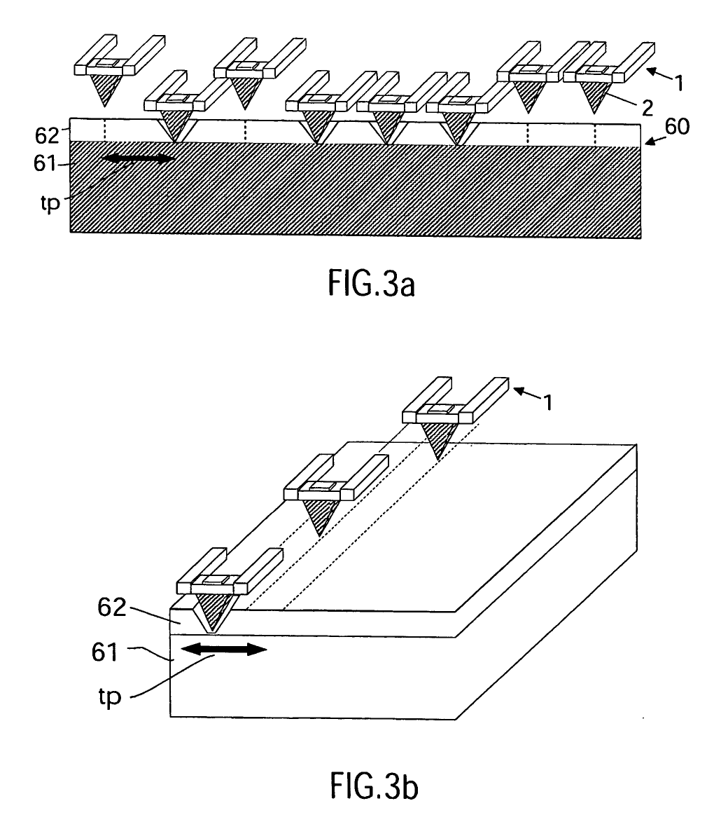

FIG. 3 shows a second embodiment of a device according to the invention having a multiple tip arrangement,

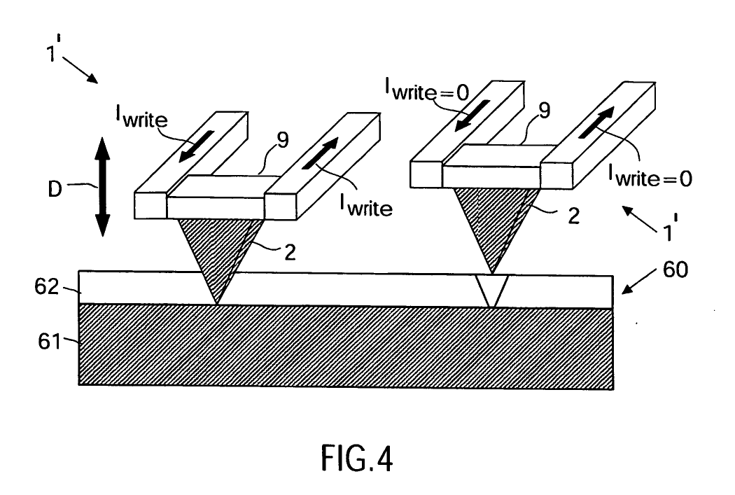

FIG. 4 shows a third embodiment of a device according to the invention,

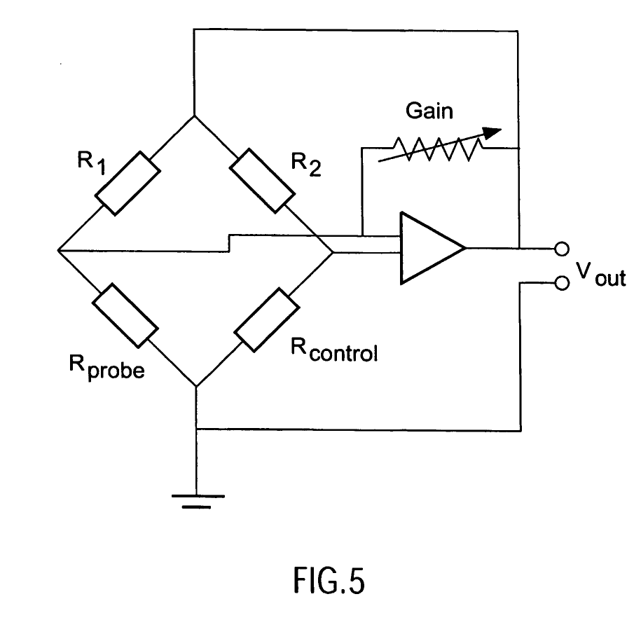

FIG. 5 shows a Wheatstone bridge for control of the tip,

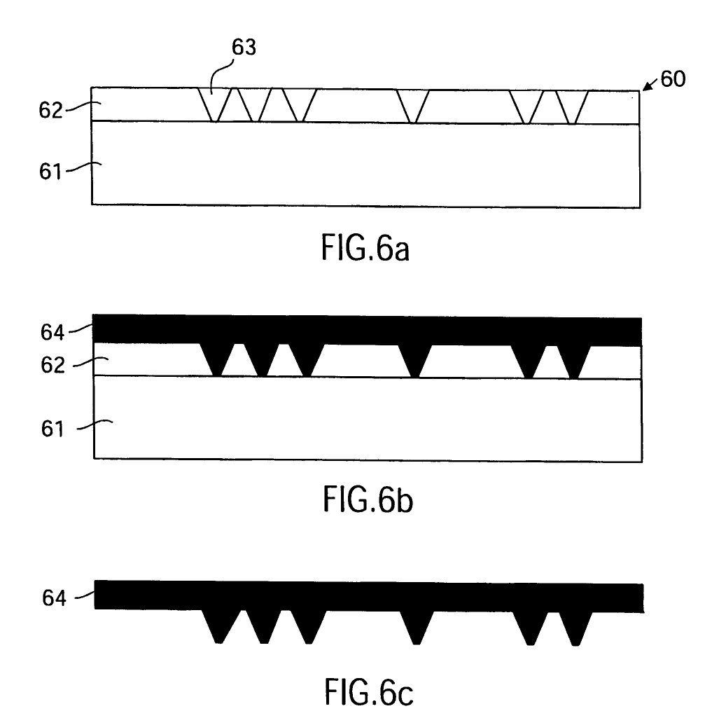

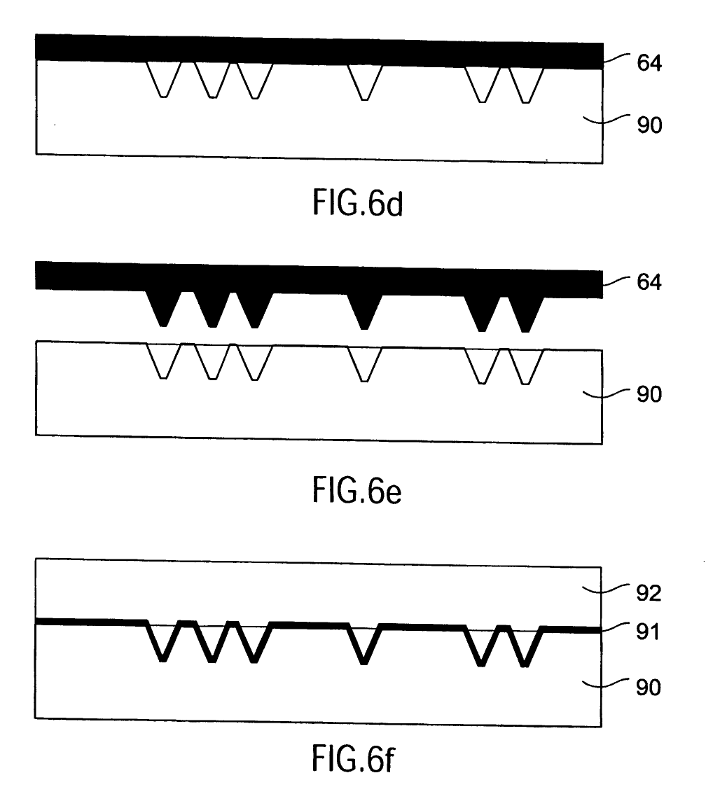

FIG. 6 illustrates the steps of the method for making a stamper and replicated medium,

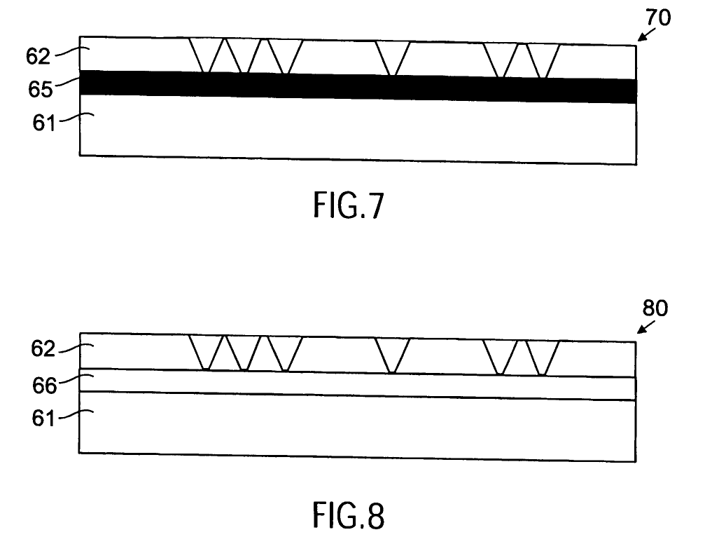

FIG. 7 shows a first embodiment of a record carrier according to the invention, and

FIG. 8 shows a second embodiment of a record carrier according to the invention.

As mentioned above the invention is generally applicable to any kind of optical recording. However, the invention is particularly suited for use in 2D data storage. An example of a two-dimensional hexagonal data pattern having a honeycomb structure as proposed for two-dimensional optical recording is shown in FIG. 1. Each hexagon represents a 1-bit information. Of course, other types of data patterns are also possible, such a rectangular, a square grid or a triangular grid.

2D data storage is based on encoding data in a two-dimensional pattern. The data track pitch and bit length are much smaller than the optical spot. In this way, marks present in the adjacent tracks are also partly readout by the sides of the optical spot resulting in cross-talk. In two-dimensional optical recording, this optical cross-talk is utilized to store data in the second (radial) direction as well.

A schematic of the set-up of a recording apparatus according to the present invention is shown in FIG. 2 in a recording position (left side) and a non-recording position (right side). The apparatus comprises a recording head 1 having at least one tiny AFM-like tip 2 that can be heated and used to indent a thin layer 62 of organic material deposited over a substrate layer 61 of a record carrier 60. When the hot tip 2 interacts with the thin organic layer 62, a small indentation 63 is locally formed in the layer 62, resulting from the combined action of mechanical pressure and thermal softening of the organic material (such as melting, decomposition or evaporation).

The vertical displacement of the hot tip 2, i.e. displacement in a direction D perpendicular to the surface of the record carrier 60, is controlled via laser light reflection of a laser beam L generated by a light source 3 on a mirror 4 that is mounted on a cantilever 5, very similar as is done in conventional atomic force microscopy, and is detected by a place-sensitive detector 6. The vertical displacement is enabled by a piezo-electric actuator, a thermo-mechanical action, or other means of accurate displacement. I_{write} denotes an electric current flowing through the tip 2 during writing which is provided by a current source 7. If the recording medium 60 (i.e. the disc) is rotated or translated via a meandering displacement underneath the tip 2, an indentation (pits) pattern can be created if the tip 2 is operated in a pre-defined pulse sequence that corresponds to a required data pattern. For control of the light source 3, the detector 6 and the current source 7, thus indirectly controlling the displacement and the heating of the tip 2, a control unit 8 is provided.

The shape of the AFM tip 2 in combination with the organic layer thickness determines the size of the craters 63 and thus pits. Sizes between 40 nm and 1000 nm are feasible. The tip shape can be adapted to the required pit wall angle and pit shape. Sizes below 40 nm are even feasible if the tip shape and size and the layer thickness are properly selected.

Examples of a multiple tip arrangement are shown in FIG. 3 where eight recording heads 1 each comprising a single AFM tip 2 are located in an array arrangement. In a first arrangement as shown in FIG. 3a the tips 2 are aligned horizontally which is possible when the tips 2 are smaller than the track pitch is. Such a situation can be envisioned in case the tips 2 are integrated in a silicon device, the tip assembly preferably made by lithographic processing of silicon. If the tips 2 are larger than the targeted data track pitch, as will most probably be in case of a two-dimensional data pattern, the tips 2 can also be aligned one after another, such as the staggered alignment as shown in FIG. 3b where the tips 2 are positioned at the targeted track pitch distance.

This array is used to create a two-dimensional pit pattern that is readout by a focused laser beam. The data track pitch tp and channel bit length are of the order of magnitude of ⅓ to ⅔ of the optical spot size. For Blu-Ray Disc conditions, a data track pitch and channel bit length of 150-200 nm is anticipated while the optical spot size is 300 nm.

A single or multiple tip arrangement can also be made with piezo-actuation as illustrated in FIG. 4. The vertical displacement of the recording head 1′ is again controlled via a laser beam reflected on a mirror and detected by a place-sensitive detector (not shown); however, the individual tips 2 are just actuated with a piezo-electric crystal or piezo-electric ceramics 9. Since the movement of the tip 2 is blocked by the inert substrate 61 of the record carrier, an even simpler actuation system can be thought of. For example, the tip can be mounted on a thermo-mechanical cantilever. The cantilever, including the tip 2, bends when a current passes the thermo-mechanical element due to a difference in thermal expansion between two parts of the element. The inert substrate 61 prevents further displacement of the cantilever and allows the cantilever to only penetrate the organic information layer 62.

The tip is embedded in a so-called Wheatstone bridge electric circuit as shown in FIG. 5 in order to enable an accurate temperature control of the tip. The tip is schematically indicated in the bridge as resistor R_{probe}, the other resistors of the bridge are indicated as R_{control}, R₁ and R₂. An accurate adjustment is possible by changing the resistance of the resistor R_{control} if a material with a high temperature-dependent electric resistance is selected for the tip (thus R_{probe}), for example Tungsten. A change in temperature is then sharply related to a change in electrical resistance and the unbalance of the bridge is directly compensated.

An AFM-probe that can be heated is used in a so-called scanning thermal microscope as described in the above mentioned article of E. Meinders. Thermal probes are nowadays commonly used to analyze the thermal topography of samples. These thermal AFM probes are used to measure the surface topography and at the same time the heat flow rate to the sample of investigation. From a proper calibration, the thermal properties of the surface and vicinity of the surface can be imaged.

The temperature of the tip needs to be accurately controlled because of the reproducibility of the indented pits. The total volume of the indent is namely directly related to the achieved temperature and contact pressure.

A cross sectional view of a recording medium 60 used according to the invention as master record carrier is shown in FIG. 6a. It consists of a substrate 61 of glass, silicon, or other type of inert material with a thin spincoated organic film 62 on top of it. During indentation, the hot tip locally deforms the organic material due to the softening of the organic layer 62, in particular by a decrease in viscosity of the film at elevated temperatures, enabling the tip to create a crater 63. The stiffness or mechanical resistance vanishes, for example, upon melting of the layer 62. The inert substrate 61 is not affected by the hot tip and therefore serves as a natural blockage of the tip. In this way, the generated indentations 63, in this case representing a two-dimensional indentation pattern, have uniform depths and widths, imposed by the initial layer thickness of the organic film 62.

The information layer 62 can also consist of a metal with a low melting temperature. Other types of materials are also possible, provided that the tip can thermally create an aperture in the layer 62, and the substrate 61 is inert for that temperature rise.

The medium 60 is further processed in a similar way as the exposed and developed photo-sensitive resist layers, as used in LBR mastering. A metallic or other material 64 is sputter-deposited on the indented medium 60 as shown in FIG. 6b. In case Ni is used as material, the initial sputter-deposited layer is made thicker by growing material (Ni) on top of the layer 64. In this case a robust and thick metallic Ni (or other material) layer is obtained that can be separated from the medium 60 by, for example, pealing off. This metallic layer with protrusions is called stamper 64 and is shown in FIG. 6c.

This stamper 64 can be considered as a negative and contains the inverted data pattern as was created in the medium 60 by indentation. In a further process step, this stamper 64 is used to make a replication 90, as shown in FIG. 6d. This replication 90 contains a similar data pattern as the indented medium 60. After making the replication 90 the stamper is separated from the replicated medium, as shown in FIG. 6e.

Subsequently a metallic or other mirror layer 91 is deposited on the replicated side of the medium 90. For BD-ROM applications, additionally, a cover layer 92, e.g. a 100 μm readout cover layer 92, is glued to the replicated medium 90 on top of the mirror layer 92 as shown in FIG. 6f.

In another embodiment of a recording medium 70 shown in FIG. 7, a thin interface layer 65 is present in between the organic layer 62 and the substrate 61. This interface layer 65 is used to control the heat diffusion through the organic layer 62, in this way controlling the size and shape of the written pit. The interface layer 65 can be a metal layer in case the substrate 61 is made of glass (or other material with a low thermal conductivity) while it may be an insulator in case the substrate 61 is highly conductive, such as silicon or metallic substrates.

A still further embodiment of a recording medium 80 according to the present invention is shown in FIG. 8. Therein, a photo-sensitive layer 66 is provided between the organic information layer 62 and the substrate 61. By use of such a photo-sensitive layer 66 it is possible, to reduce the thickness of the organic information layer 62. By use of the tips, indentations are burnt in the organic information layer 62, but not in the photo-sensitive layer 66 since thermal damage of this layer 66 is preferably prevented by, for instance, a higher melting temperature. In a subsequent step, the entire disc 80 is illuminated with UV radiation. Thus, a physical mask has in fact been created by the indented organic information layer 62 on top of the photo-sensitive layer 66. Subsequently, the illuminated areas are developed to end up with deep pits, the depth of the pits being determined by the thickness of the photo-sensitive layer 66. Thus, in this way and by use of the recording medium 80 a master record carrier can be easily made from which thereafter a stamper can be produced in the way described above.

It is to be noted that the application of a UV source depends on the kind of photo-resist (photo-sensitive) layer 66. In the described embodiment, the photo-resist layer 66 is sensitive for UV light. In that case, a master record carrier is written, for example, for Blu-ray disc-kind of applications. Other types of photo-resist layers can be sensitive in a different wavelength region. If the photo-resist layer 66 is sensitive for blue or red laser light, the source of illumination is adapted thereto.

In another embodiment, an additional interface layer, similar like interface layer 65 shown in FIG. 7, is located in between the photo-resist layer 66 and substrate 61. This interface layer can be beneficial for controlling the heat flow during indentation (writing of pits) but it may also serve as a chemical barrier between the photo-resist and substrate during illumination with the UV or other light source.

The described method can also be used to make ROM media for future generation storage systems requiring bit lengths below 80-100 nm, for example a system based on an UV laser and high NA optics.

1. Device for making a master record carrier (60) for use in making a stamper (64) for making replicated read-only optical record carriers (90), comprising:
a recording head (1) for recording information in an information layer (62) of a master record carrier (60), said recording head (1) including a heatable tip (2) which can be displaced in at least one direction,
a displacement means (3, 5, 6, 9) for displacing said tip (2) in the at least one direction,
a heating means (7) for heating said tip (2) and
a control unit (8) for controlling said heating means and said displacement means such that for recording a mark said tip is heated and displaced to be in contact with said information layer causing an indentation therein.

2. Device as claimed in claim 1,
wherein said heating means comprises a current source (7) for providing an electric current for flowing through said tip (2) when a mark shall be recorded.

3. Device as claimed in claim 1,
wherein said recording head (1) further comprises a light deflection means (4) and wherein said displacement means comprises
a light generation unit (3) for providing a light beam (L), in particular a laser beam, to be directed onto said deflection means (4) and
a light detection unit (6) for detection of light deflected by said deflection means (4).

4. Device as claimed in claim 1,
wherein said displacement means comprises an actuator (5, 9), in particular a piezo-electric actuator or a thermo-mechanical cantilever, which is included in said recording head (1), for causing the displacement of said tip (2) under control of said control unit (8).

5. Device as claimed in claim 1,
wherein said tip (2) has a conical shape, the top of said conical tip (2) facing said information layer (62).

6. Device as claimed in claim 1,
wherein said tip (2) comprises a metal wire, in particular made of platinum or tungsten.

7. Device as claimed in claim 6,
wherein said metal wire is covered by a tube, in particular a Wollaston tube.

8. Device as claimed in claim 1,
wherein said control unit (8) comprises a Wheatstone bridge, said tip (2) being electrically one bridge element thereof.

9. Device as claimed in claim 1,
comprising an array of recording heads (1) each comprising a heatable tip (2), which can be independently heated and displaced under control of said control unit (8).

10. Method of making a master record carrier (60) for use in making a stamper (64) for making replicated read-only optical record carriers (90), comprising the step of recording information in an information layer (62) of a master record carrier (60), wherein a mark is recorded by the steps of heating the tip (2) and displacing the tip (2) to be in contact with said information layer (62) causing an indentation therein.

11. Method as claimed in claim 10,
wherein said method is used, for simultaneously recording more than one information, in particular for simultaneously recording more than one subsequent channel bits of a 1D channel code, more than one channel bits of parallel tracks of a 1D channel code or more than one channel bits of parallel bit rows of 2D channel code.

12. Device for making a stamper (64) for making replicated read-only optical record carriers (90), comprising:
a device for making a master record carrier (60) as claimed in claim 1,
means for depositing a metallic layer (64) on top of said information layer (62), and
means for separating said deposited metallic layer (64) from said information layer (62) to obtain said metallic layer (64) forming said stamper.

13. Device as claimed in claim 12,
wherein said master record carrier (80) comprises an additional photo-sensitive layer (66) between said information layer (62) and a substrate layer (61), further comprising:
a light source illuminating the information layer (62), after the information has been recorded therein, to cause a photo-chemical reaction in said photo-sensitive layer (66) and
means for developing said photo-sensitive layer (66) before a metallic layer (64) is deposited on top of the information layer (62).

14. Device as claimed in claim 13,
wherein said light source is an UV source for illuminating said information layer (62) by UV radiation.

15. Method of making a stamper (64) for making replicated read-only optical record carriers (90), comprising the steps of:
making a master record carrier (60) by a method as claimed in claim 10,
depositing a metallic layer (64) on top of said information layer (62), and
separating said deposited metallic layer (64) from said information layer (62) to obtain said metallic layer (64) forming said stamper.

16. Record carrier for use as master record carrier (70) by a device as claimed in claim 1, comprising:
a substrate layer (61),
an information layer (62), and
an interface layer (65), in particular a metallic interface layer (65), between said substrate layer (61) and said information layer (62) for control of the heat diffusion through said information layer (62).

17. Record carrier for use as master record carrier (80) by a device as claimed in claim 13, comprising:
a substrate layer (61),
an information layer (62), and
a photo-sensitive layer (66) between said substrate layer (61) and said information layer (62).

18. Record carrier as claimed in claim 17, further comprising a metallic interface layer between said photo-sensitive layer (66) and said information layer (62) for control of the heat diffusion through said information layer (62).

19. Record carrier as claimed in claim 16,
wherein said information layer (62) is substantially made of an organic material.
